(19) United States
(12) Patent Application Publication
(10) Pub. No.: US 2026/0366958 A1
(43) Pub. Date: Nov. 19, 2026

(54) DEVICE AND METHOD FOR DETERMINING AN IMAGING QUALITY OF AT LEAST ONE IMAGE FOR AN INSPECTION ITEM

(71) Applicant: TRIOPTICS GmbH, Wedel (DE)

(72) Inventors: Aiko RUPRECHT, Wedel (DE); Daniel WINTERS, Wedel (DE); Jan-Hinrich EGGERS, Wedel (DE); Johannes HINRICHS, Wedel (DE)

(73) Assignee: TRIOPTICS GmbH, Wedel (DE)

(21) Appl. No.: 19/136,847

(22) PCT Filed: Dec. 6, 2023
(86) PCT No.: PCT/EP2023/084483

§ 371 Date: Jun. 6, 2025

(30) Foreign Application Priority Data
Dec. 7, 2022 (DE) 10 2022 132 453.2

(51) Int. Cl. G01M 11/02

(52) U.S. Cl. CPC G01M 11/0264; G01M 11/0285

(57) ABSTRACT

The invention relates to an apparatus (100) for determining an imaging quality of at least one image representation for a test specimen (105), said apparatus comprising at least one projection unit (115) for emitting light (120) in the direction of the test specimen (105) in order to project at least one luminous and/or illuminated object structure through the test specimen (105), an optical receiver unit (110) for receiving light beams (130) of light (120) representing at least one image representation of the projected object structure, a mounting unit (145) arranged between the projection unit (115) and the optical receiver unit (110); and a computing unit (150) for simultaneously evaluating a first light parameter, which represents at least one optical light parameter, and a second light parameter, which represents at least one colorimetric or photometric light parameter, of light beams (130) transmitted through or reflected off the test specimen (105), in order to determine the imaging quality of the at least one image representation, wherein the computing unit (150) is connected to the projection unit (115), to the receiver unit (110) and/or to the mounting unit (145).

### PRIOR ART

Starting point for the invention is an apparatus and a method for determining an imaging quality of at least one image representation for a test specimen, according to the preamble of the independent claims. The subject matter of the present invention also relates to a computer program.

U.S. Pat. No. 11,029,206 B2 describes equipment for measuring and characterizing the performance of augmented and virtual reality waveguide structures using glass substrates.

Against this background, the approach presented here provides an improved apparatus and an improved method for determining an imaging quality of at least one image representation for a test specimen, furthermore a computing unit that uses this method and finally a corresponding computer program according to the main claims. Advantageous developments and improvements of the apparatus specified in the independent claim are possible by way of the measures set out in the dependent claims.

The approach presented here allows the development of means for being able to reliably determine properties of a test specimen. For example, the apparatus may be used as a measuring apparatus in this respect. Advantageously, this may lead to an improvement in a quality of the test specimen and hence of, for example, a near eye display (NED), as may be used for example in connection with smartglasses, augmented reality (AR) or virtual reality (VR). For example, the images can be displayed in focus, and this may have a positive effect on the health of an end user. Advantageously, it is possible to use both imaging colorimeters and imaging photometers and also systems for measuring optical parameters in order to simultaneously attain a color measurement and an improvement in the systems for measuring optical parameters.

An apparatus is presented for determining an imaging quality of at least one image representation for a test specimen, wherein the apparatus comprises at least one projection unit for emitting light in the direction of the test specimen in order to project at least one luminous and, additionally or alternatively, illuminated object structure onto the test specimen. Furthermore, the apparatus comprises an optical receiver unit for receiving light beams of light transmitted through or reflected off the test specimen, said light beams representing at least one image representation of the projected object structure. In this context, the receiver unit comprises an optics device and an optical detector. Moreover, the apparatus comprises a mounting unit for holding the test specimen to be tested, wherein the mounting unit is arranged between the projection unit and the optical receiver unit, and a computing unit for simultaneously evaluating a first light parameter, which represents at least one optical light parameter, and a second light parameter, which represents at least one colorimetric or photometric light parameter, of light beams of light transmitted through or reflected off the test specimen and received using the receiver unit, in order to determine the imaging quality of the at least one image representation for the test specimen. In this context, the computing unit is connected to the projection unit, to the receiver unit and, additionally or alternatively, to the mounting unit.

For example, the apparatus may be a measuring apparatus for augmented reality (AR) systems or virtual reality (VR) systems—which may also be referred to simply as AR/VR—by means of which properties of the test specimen can be measured. For example, the test specimen may take the form of a lens for smartglasses or AR/VR equipment, which may also be referred to as a near eye display (NED) and on or against which images can be imaged, for example. Furthermore, the test specimen may for example also take the form of a complete system, for which the imaging quality can be determined. To this end, it is advantageous to determine the imaging properties in advance. Thus, the test specimen may take the form of an optical system to be tested, a waveguide, a combination of waveguides or, alternatively, a module which may comprise an illumination unit and a waveguide. In this context, the module may be capable of generating a self-luminous object structure that may be capturable by the receiver unit. Advantageously, the object structure may represent a pattern, image or symbol to be imaged on the test specimen.

The projection unit may advantageously comprise a light source, for example a light-emitting diode (LED). Furthermore, the projection unit may be aligned with the test specimen such that light can be transmitted through the test specimen or reflected off the latter. Advantageously, the light may either be transmitted directly through the test specimen or enter the test specimen at an entrance point and for example be reflected off opposing faces of the test specimen until an exit point of the test specimen is reached. The exit point may advantageously be in line with the receiver unit such that the transmitted or reflected light beams can be received by the receiver unit. The receiver unit may advantageously comprise the optics device, which may for example comprise lenses or other optical elements, and the detector. The detector may advantageously likewise comprise a plurality of components, by means of which the light beams and, additionally or alternatively, information transported by said light beams may be captured. The computing unit may advantageously take the form of a control unit or a controller that is designed to process this information. In this case, the information may be transported and evaluated on the basis of the light parameters, which in turn allow an inference or calculation of the imaging quality of the image representation. In order to be able to obtain a meaningful result, the apparatus may comprise a mounting unit to which the test specimen can be attached. The mounting unit may advantageously take a movable or displaceable form such that, using the computing unit, the imaging quality may be determined in relation to different positions of the test specimen. The mounting unit may advantageously take the form of a multi-axis linear stage which can allow free positioning of the test specimen in space and which can accordingly be displaced, either once or repeatedly, along an x-, y- or z-axis, for example.

According to an embodiment, the detector associated with the receiver unit may comprise a plurality of spectral channels and at least one image sensor. In this case, the spectral channels may be implemented e.g. with the aid of a filter unit. Advantageously, the filter unit may take the form of a filter wheel with a plurality of optical filters. For example, such filters may take the form of an optical quality glass or plastic panel, which can be introduced into the beam path of the receiver unit, e.g. by pivoting, in order to be able to obtain a defined wavelength spectrum in the image. Alternatively, the spectral channels may be realized by way of a plurality of image sensors that each have one spectral filter. In both variants, the spectral filters may additionally be combined with neutral-density filters in order to uniformly attenuate the incident, optical intensity on the image sensor, with the object of preventing possible overexposure of the sensor. Accordingly, the detector may be realized as a sensor unit, for example. It is also conceivable that the detector associated with the receiver unit is realized as a focusable camera.

Furthermore, the receiver unit may comprise the optics unit, which may be diffraction-limited for an entire capturable field angle. Advantageously, the optics unit may comprise at least one lens, in particular a plurality of lenses, which may be designed so as to be able to guide the light beams to the detector. The resolution of optical instruments, the optics device in this case, may in this context be limited by diffraction in conjunction with the field angle. To this end, the field angle may for example be a characteristic for a field of view of the receiver unit, i.e. be related to a capture region.

The optics device may comprise interchangeable components and at least one adjustable optics aperture stop, which may be designed to be able to adapt geometric properties of the beams incident into the optics device, in particular the diameters of said beams. For example, in terms of its design, the optics device may be similar to a conoscope. For example, the adjustable aperture stop may be used to simulate the iris diameter in the human eye. Advantageously, the optics aperture stop may be physically or virtually adjustable and additionally for example take the form of an opening through which the light beams can be received. By adjusting the optics aperture stop, it is advantageously possible to determine the amount of light received such that the light conditions may be correct.

According to an embodiment, the projection unit may take the form of a focusable or non-focusable collimator, which in particular may comprise at least one monochromatically and, additionally or alternatively, polychromatically illuminated or illuminable line element. Accordingly, the receiver unit comprises an imaging telescope to image the image generated by the collimator at infinity onto the sensor. In this case, a collimator may be designed to be able to generate light with an approximately parallel beam path from a divergent source. As a result, the light may advantageously be steered in a specific direction. For example, monochromatic may relate to a light emission in a very narrow wavelength range. Accordingly, polychromatic may relate to multicolored light which comprises a mixture of different colors and which therefore may be spectrally broadband and comprise different wavelengths. Advantageously, the line element may also be referred to as reticule or as reticle.

Furthermore, the projection unit may comprise the at least one line element with a plurality of different object structures. In an alternative, the projection unit may comprise an interchange mechanism for sequentially introducing different line elements with different object structures into a beam path of the light. In particular, the object structures may represent large-area elements, sharp edges and, additionally or alternatively, lines. For example, the line element with the plurality of different object structures may be referred to as a multi-feature reticle. Accordingly, the object structures may be patterns for example, which comprise bent or straight contours or lines. Accordingly, the object structures are realizable, inter alia, as for example a circle, quadrilateral or cross, which may for example be displayed on or by the test specimen.

According to an embodiment, the object structures may be generated or generable with the aid of a self-luminous element. In addition to that or in an alternative, the projection unit may comprise an adjustable projection aperture stop. The object structures may advantageously be realized as virtual structures. In order to be able to image these, the projection unit may for example comprise the projection aperture stop which, in a manner similar to the optics aperture stop, may take the form of an opening through which the light can be transmitted. Advantageously, the projection aperture stop may be realized physically or virtually and, in addition to that or in an alternative, be adjustable in order to restrict the diameter of the beam emerging from the projection unit. Furthermore, the projection unit may optionally comprise an additional projection field stop, which in turn is optionally adjustable in order to adapt the field angle of the emerging beams.

Moreover, the apparatus may comprise a movable first goniometer, which may be connected to the projection unit, and a movable second goniometer, which may be connected to the receiver unit, wherein the first and second goniometers may be designed to be able to move the projection unit and the receiver unit independently of one another in at least two different directions about their respective single defined points of rotation. In particular, the first goniometer and, additionally or alternatively, the second goniometer may be translationally movable in at least three spatial directions relative to the test specimen. The goniometer or goniometers may for example also be referred to as angle measuring units which for example are able to measure an angle between the projection unit and the receiver unit. This means that the goniometers may be connected to one another and their respective single free ends may be connected to the projection unit and the receiver unit respectively. As a result, the projection unit and the receiver unit may advantageously be moved in different directions in order to be able to measure and determine the imaging quality of the test specimen from different positions and accordingly different incoming radiation directions of the light. The goniometers may advantageously be pivoted.

A method for determining an imaging quality of at least one image representation for a test specimen using an apparatus in an aforementioned variant is also presented, wherein the method comprises a step of emitting light using a projection unit in order to be able to project at least one luminous and, additionally or alternatively, illuminated object structure onto the test specimen. Moreover, the method comprises a step of receiving, using the receiver unit, light beams of light transmitted through or reflected off the test specimen, said light beams representing at least one image representation, and a step of simultaneously evaluating a first light parameter, which represents at least one optical light parameter, and a second light parameter, which represents at least one colorimetric or photometric light parameter, of light beams of light transmitted through or reflected off the test specimen, in order to determine the imaging quality of the at least one image representation using the computer unit.

The imaging quality of the test specimen, which may for example be used in conjunction with smartglasses or AR/VR systems, can advantageously be determined by way of the method. By determining the imaging quality, it is advantageously possible to ascertain or verify a sharpness of the image representations. Within the scope of the emission step, the light may for example be emitted for a duration that may advantageously be adjustable.

According to an embodiment, further light beams of light transmitted through or reflected off the test specimen may be received in the reception step, said further light beams being capable of representing at least one further image representation. In the evaluation step, a further first light parameter, which may represent at least one further optical light parameter, and a further second light parameter of the further light beams, which may represent at least one further colorimetric or photometric light parameter, may be evaluated simultaneously in order to be able to determine a further imaging quality of the further image representation. In particular, the image representation and the further image representation may be captured at respective different exposure times. In this context, the exposure time for emitting the light for the image representations may for example be the same or alternatively differ.

The method may further comprise a step of combining the image representation and the further image representation to form an overall image after the evaluation step. For an exposure time that differs for the image representations, the overall image may advantageously be generated as a high dynamic range (HDR) image, i.e. as an image with large brightness differences. In an alternative, for different spectral settings of the light beams, the image representations may generate an overall color image using the light parameters. These may be determined merely optionally for individual images or for overall images.

According to an embodiment, the method may moreover comprise a step of compensating for aberrations using predetermined calibration data before the evaluation step. By the step of compensation, aberrations may advantageously be corrected in order to improve the imaging quality before the light parameters for determining the imaging quality are evaluated. The calibration data may advantageously be stored in a memory unit.

This method may be implemented for example in software or hardware or in a mixed form composed of software and hardware, for example in a controller.

The approach presented here also develops a computing unit that is designed to perform, control or implement the steps of a variant of a method presented here in corresponding devices. The problem addressed by the invention may also be solved quickly and efficiently by this embodiment variant of the invention in the form of a computing unit realized as a controller.

To this end, the computing unit for processing signals or data may comprise at least one memory unit for storing signals or data, at least one interface to a sensor or to an actuator for reading sensor signals from the sensor or for outputting data signals or control signals to the actuator and/or at least one communications interface for reading or outputting data which are embedded in a communications protocol. For example, the computing unit may be a signal processor, a microcontroller or the like, wherein the memory unit may be a flash memory or a magnetic memory unit. The communications interface may be designed to read or output data wirelessly and/or using cables, wherein a communications interface that is capable of reading or outputting data using cables may read these data for example electrically or optically from a corresponding data transfer line or output these data for example electrically or optically into a corresponding data transfer line.

In the present case, a computing unit may be understood to mean electrical equipment that processes sensor signals and outputs control signals and/or data signals on the basis thereof. The computing unit may comprise an interface that may be designed in terms of hardware and/or software. In the case of a hardware design, the interfaces may for example be part of what is known as a system ASIC, which contains a very wide variety of functions of the apparatus. However, it is also possible that the interfaces are separate, integrated circuits or consist at least partly of discrete component parts. In the case of a software design, the interfaces may be software modules, which are for example present on a microcontroller in addition to other software modules.

Exemplary embodiments of the approach proposed here are depicted in the drawings and are explained in detail in the following description. In the drawings:

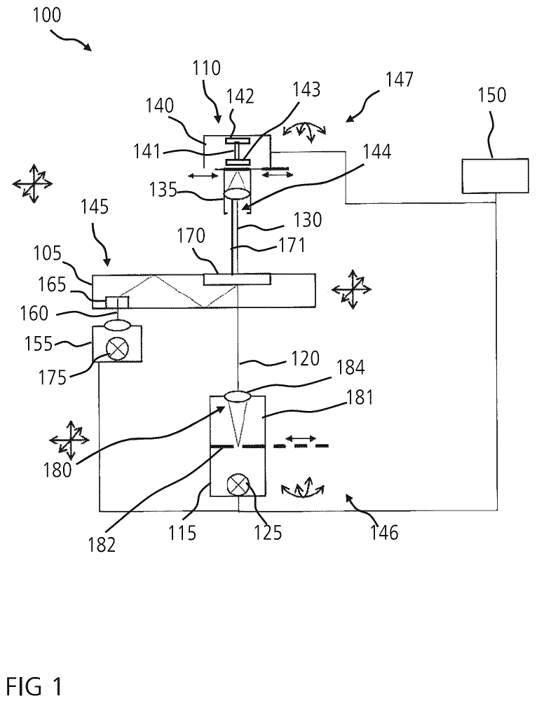

FIG. 1 shows a schematic illustration of an apparatus according to an exemplary embodiment;

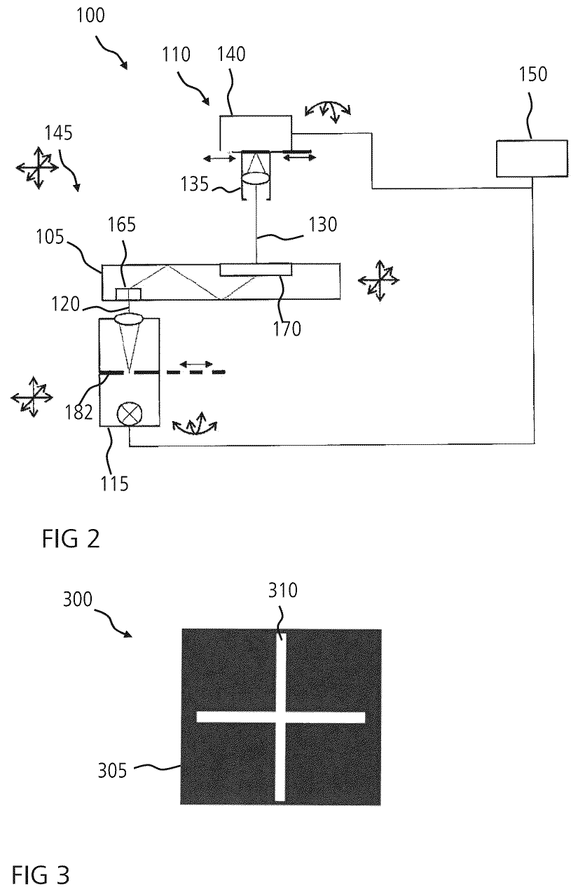

FIG. 2 shows a schematic illustration of an exemplary embodiment of an apparatus;

FIG. 3 shows a schematic illustration of an exemplary embodiment of an object structure for an apparatus;

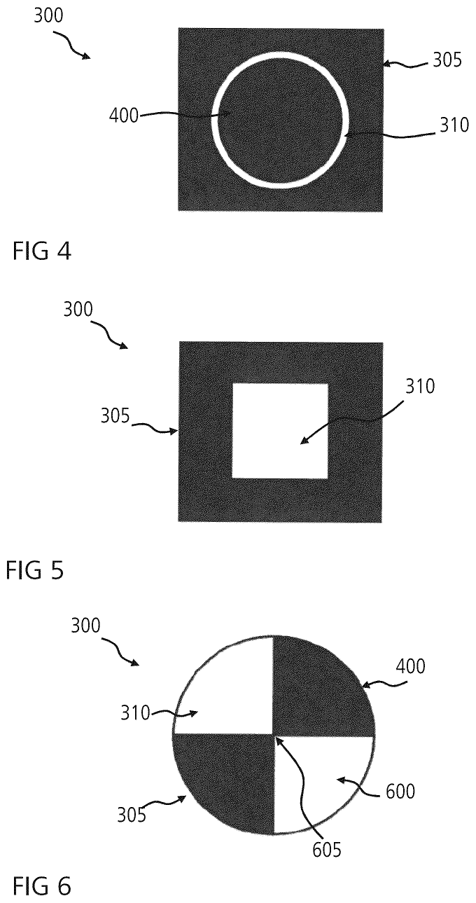

FIG. 4 shows a schematic illustration of an exemplary embodiment of an object structure for an apparatus;

FIG. 5 shows a schematic illustration of an exemplary embodiment of an object structure for an apparatus;

FIG. 6 shows a schematic illustration of an exemplary embodiment of an object structure for an apparatus;

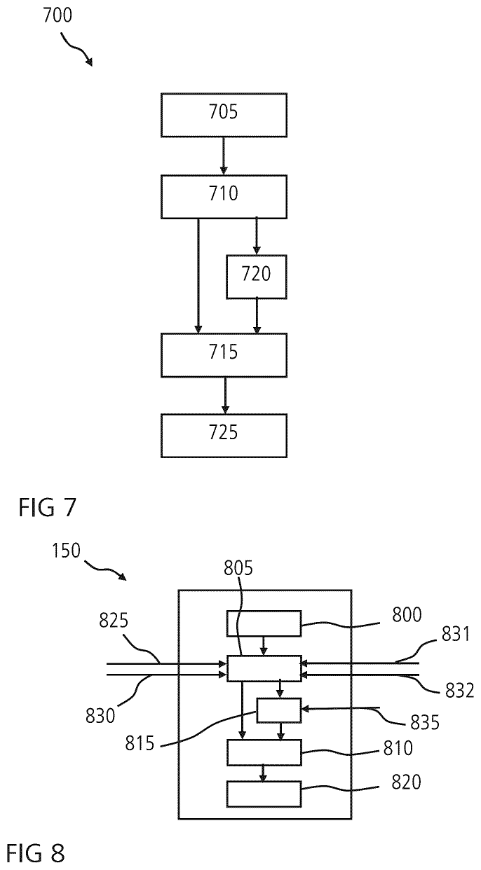

FIG. 7 shows a flowchart of an exemplary embodiment of a method for determining an imaging quality of an image representation for a test specimen; and

FIG. 8 shows a block diagram of a computing unit according to an exemplary embodiment for an apparatus.

In the following description of beneficial exemplary embodiments of the present invention, identical or similar reference signs are used for the elements of similar action which are illustrated in the various figures, wherein a repeated description of such elements is omitted.

Where an exemplary embodiment comprises an “and/or” conjunction between a first feature and a second feature, this should be read as meaning that the exemplary embodiment in accordance with one embodiment has both the first feature and the second feature, and in accordance with a further embodiment has either only the first feature or only the second feature.

FIG. 1 shows a schematic illustration of an apparatus 100 according to an exemplary embodiment. For example, the apparatus 100 is realized as a measuring apparatus that is embodied to determine an imaging quality of at least one image representation for a test specimen 105. Accordingly, different optical systems whose imaging quality should be measured or determined may be arranged in or on the apparatus 100. In this case, the test specimen 105 takes the form of for example a waveguide, a combination of waveguides or a module that takes the form of a combination of an illumination unit and a waveguide. In this context, the module is for example capable of generating a self-luminous object structure that is capturable by a receiver unit 110 of the apparatus 100.

Accordingly, the apparatus 100 comprises at least one projection unit 115 for emitting light 120 in the direction of the test specimen 105 in order to project at least one luminous and/or illuminated object structure onto the test specimen 105. It is merely optional for the projection unit 115 to comprise an illumination unit, i.e. a light source 125 that generates the light 120. In this context, the aforementioned optical receiver unit 110 is also part of the apparatus 100. The receiver unit 110 is designed to receive light beams 130 of light 120 transmitted through or reflected off the test specimen 105. In this case, the light beams 130 represent the at least one image representation of the projected object structure. Furthermore, the receiver unit 110 comprises an optics device 135 and a detector 140. For example, the detector 140 comprises a plurality of spectral channels 141, an image sensor 142 and at least one filter unit 143, for example a filter wheel with color filters (e.g. V(lambda) filters) and an additional optional neutral-density (ND) filter. For example, the optics device 135 is diffraction-limited for an entire capturable field angle. Furthermore, the optics device 135 comprises interchangeable components and at least one physically or virtually adjustable optics aperture stop 144, which is designed to adapt the diameter of the beams incident into the optics device. For example, in terms of its design, the optics device may furthermore correspond to a conoscope.

According to this exemplary embodiment, both the projection unit 115 and the receiver unit 110 are arranged in movable and in particular pivotable fashion. Furthermore, they are arranged so as to be located on a common line in this exemplary embodiment, said line for example corresponding to a beam path of the light 120 and the light beams 130 in this case. In this case, the test specimen 105 is arranged between the projection unit 115 and the receiver unit 110. More precisely, the apparatus 100 comprises a mounting unit 145 which is embodied to hold the test specimen 105. The mounting unit 145 also has a movable embodiment in this exemplary embodiment, in order to move the test specimen 105 in the x-, y- and z-directions of a coordinate system. For example, the apparatus 100 according to this exemplary embodiment comprises a movable first goniometer 146, which is also referred to as an angle measuring unit and which is connected to the projection unit 115, and a movable second goniometer 147, which is connected to the receiver unit 110. In this context, the first goniometer 146 and the second goniometer 147 are designed to move the projection unit 115 and the receiver unit 110 independently of one another in at least two different directions about their respective single defined points of rotation. In particular, the first goniometer 146 and/or the second goniometer 147 is or are translationally movable or displaceable in at least three spatial directions relative to the test specimen 105.

The apparatus 100 furthermore comprises a computing unit 150 that is designed to simultaneously evaluate a first light parameter, which represents at least one optical light parameter, and a second light parameter, which represents at least one colorimetric or photometric light parameter, of the light beams 130 of light 120 transmitted through or reflected off the test specimen 105 and received using the receiver unit 110, in order to determine the imaging quality of the at least one image representation for the test specimen 105. In this case, the computing unit 150 is connected to the projection unit 115, to the receiver unit 110 and/or to the mounting unit 145. According to this exemplary embodiment, the test specimen 105 (consisting of or comprising an AR module in this case) additionally comprises a waveguide with a further projection unit 155, which is also connected to the computing unit 150. In this case, the projection unit 115 and the further projection unit 155 are arranged or arrangeable offset from one another. For example, the projection unit 115 is arranged in such a way here that the light 120 is transmitted through the test specimen 105 in a straight line. According to this exemplary embodiment, the further projection unit 155 is arranged in such a way that for example further light 160 enters the test specimen 105 at an entrance point 165, which is also referred to as entrance pupil of said test specimen, and is reflected at surfaces of the test specimen 105 until it is incident on an exit point 170, which is also referred to as the exit pupil of the test specimen 105. The light beams 130 and/or reflected further light beams 171 of further light 160, which are subsequently received by the receiver unit 110, emerge at the exit point 170 according to this exemplary embodiment. The further projection unit 155 also comprises a further light source 175 for emitting the further light 160.

Expressed in other words, a system and then, in FIG. 7, a method are presented according to this exemplary embodiment for simultaneously measuring an overall modulation transfer function (MTF), color MTF and colorimetric or photometric parameters. Hence, the apparatus 100 is realized as an all-in-one system which allows a customer to measure substantially all light parameters, i.e. an optical and colorimetric quality of these systems, using one measuring apparatus, for example for near-eye-display (NED) systems, for example in the AR/VR sector.

The approach presented in general within this description accordingly relates to a method and an apparatus 100 for simultaneously measuring optical parameters, for example an MTF, and colorimetric or photometric parameters for components and modules of NED systems. Purely by way of example, the apparatus 100 comprises a sensor which is described here in conjunction with the receiver unit 110 and upstream of which at least one filter wheel is arranged. The filter wheel comprises filters that, individually or in combination, filter the incident light beams 130 in the totality thereof and spectrally, for example with the weighting of the color perception of the human eye. Furthermore, the receiver unit 110 comprises an optical system that is described as optics device 135 and that is attached in front of the filter wheel and has, as first element on a test specimen-side, a physical aperture 144, the diameter of which is manually or automatically modifiable by way of substitution or any other type of adjustment. An essential property of the optics device 135 is its design as diffraction-limited for an entire capturable field angle. In this case, the optics device 135 may have both a small FOV and a FOV corresponding to that of a conoscope.

As regards the measurement of colorimetric or photometric and optical parameters such as the MTF, the measurement makes use of a target that is distinguished in that both large-area homogenous elements and sharp edges or lines are present as such an object structure. In addition to a target comprising both of the features, it is also possible to use different targets with one feature each. In this case, the target is generable and projectable purely optionally by way of a self-luminous display element that is a part of the test specimen 105 or by way of a target projector that projects the target through the test specimen 105. In the case of targets having only one feature, the projection of same is implemented e.g. sequentially in the process. For example, an e.g. optional further projection unit 155 comprises a further light source 175, which is able to generate either various individual wavelengths or polychromatic light of different spectral widths. In this exemplary embodiment, the projection unit 155 is a part of the test specimen 105 and may be realized e.g. as an LCD or LCOS element. The projection unit 115 comprises a projection aperture stop 180, which is also referred to as exit aperture and located externally on the side facing the test specimen 105. Furthermore, the projection unit 115 comprises a homogeneously illuminated target template 182. The projection unit 115 may have a similar technical design to that of the further projection unit 155. The light 120, 160 is guided to an entrance pupil of the test specimen 105. In this case, the projection aperture stop 180 is realizable physically or virtually.

To measure optical and colorimetric or photometric parameters, a target as described is projected by the test specimen 105, merely by way of example by means of the target projector or by the projection by means of the test specimen 105 itself. Capture is implemented by way of a recording by means of the system as described by sequentially recording images with in each case different filtering by way of the filter wheel. In this case, the image record per filter position may contain one image or a multiplicity of images, even in the event of different exposure times. To measure optical and colorimetric parameters, the recorded data are transmitted to and processed by the computing unit 150. For example, without this being exhaustive, processing contains combining images of different exposure times to form what are known as high dynamic range images, combining images with different color weightings to form color images and/or correcting distortions in individual and overall images. Furthermore, the processing optionally contains correcting the captured data by way of calibration data sets and calculating optical and colorimetric parameters. In this case, the colorimetric parameters are ascertained purely by way of example by means of large-area structures, while the optical parameters, for example the MTF, are ascertained in parallel on the basis of edges and lines.

Furthermore, the apparatus 100 comprises at least one goniometer 146, 147; in more detail, the projection unit 115 and the receiver unit 110 are each arrangeable on a goniometer 146, 147, allowing an independent two-axis rotation of both elements about respective rotation points. For example, the rotation points of the respective systems are found at a location of respective stops, e.g. of the test specimen or of the projection or receiver unit, with any other position likewise being realizable. According to this exemplary embodiment, both goniometers 146, 147 provide the option of being manually or automatically displaced, either once or repeatedly, in at least the X-and Y-direction, and optionally in the Z-direction as well. In this case, the task of the goniometers 146, 147 lies in independent positioning of the receiver unit 110 and projection unit 115 relative to the test specimen 105, such that at least an optics aperture stop 144 of the receiver unit 110 is adjustable at a defined measurement location and at a defined angle vis-à-vis the test specimen 105. If necessary, an exit pupil of the target projector is also alignable in terms of location and angle relative to the entrance pupil, in a manner corresponding to the definition. Moreover, the test specimen 105 is displaceable at least in X, Y within a plane by means of the mounting unit 145. Depending on the receiver unit 110, the measurement of a test specimen 105 is accordingly realizable by adjusting the positioning systems or by sequential positioning, recording and measurement at different locations and angles. In this case, the locations of the system and of an optionally required target projector are found e.g. either on opposite sides of the test specimen 105 or alternatively on the same side of the test specimen 105. Test specimens 105 take the form of individual waveguides or light-guiding elements or of a combination thereof, of modules consisting of multiple identical or different components or of overall systems.

This means that the apparatus 100 and an associated method are presented, by means of which it is possible to perform a simultaneous measurement of optical imaging parameters and of colorimetric and photometric parameters for optical components or modules of near eye displays (NEDs). In this context, the term NED is understood to mean equipment which for example in the form of glasses is worn by a user and which is able either to project virtual images into the visual field of the user, for example by means of augmented, mixed or extended reality, or to generate a virtual environment, which is referred to as a virtual reality.

Optical imaging or light parameters are understood to mean such variables that characterize the imaging quality of an optical system, for example the MTF or the degree of distortion and the chief ray angle. Colorimetric and photometric light parameters are understood to mean such variables that characterize the color perception by an optical system, for example the transmitted color component or the color representation in a color space. Photometric parameters are understood to mean variables that allow a statement to be made about the emission characteristic or the amount of light transmitted by or reflected off the test specimen. These include e.g. the transmitted luminous flux or the luminous intensity. For specific definitions of the aforementioned and/or further parameters, reference is made here to the standards IEC 63145 and ISO 9241.

The approach described allows a simultaneous measurement of the aforementioned parameters, and this is applicable for example both to individual components of NEDs and to preassembled modules or even to complete systems.

Expressed differently, a first exemplary embodiment of the apparatus 100, which is described and depicted in detail in FIG. 1, is illustrated here, and its functionality is explained schematically. According to this exemplary embodiment, an assembly of an NED is shown as apparatus 100 to be tested or measured (device under test-DUT). It consists of an internal projection unit 155, which comprises an illuminated LCD element and for example a waveguide, which is designed to provide the image generated by the internal projection unit 155 for a user in a suitable manner. The apparatus 100 is secured in a mechanical mount, for example a multi-axis linear stage, which allows free positioning of the test specimen 105 in space. In more detail, the test specimen 105 is displaceable with the aid of the stage along an x-, a y- and a z-axis of a coordinate system, either once or else repeatedly. According to the exemplary embodiment depicted in FIG. 2 and described accordingly, the projection unit 115 is realized as a collimator. For example, the latter has a fixed or variable focus setting. In general, the projection unit 115 comprises the light source 125, a line element 182, which is referred to as reticule or reticle and to which a structured object pattern is applied, and an optical system 184, for instance a lens, which has a real or virtual exit aperture 180. The line element 182 is preferably linked to a diffusion panel in order to ensure a homogeneous illumination of the object pattern. Should the projection unit 115 be designed as a focusable collimator, the line element 182 may be displaced relative to the optics unit of the collimator, for example with the aid of a linear encoder, in order to simulate different object distances.

According to this exemplary embodiment, the structured object pattern advantageously contains both large-area, homogenous elements and sharp edges or lines. Both types of structure may be situated on the line element 182, which is consequently realized or realizable as what is known as a multi-feature reticle. In an alternative, a mechanical interchange mechanism may be present, by means of which different line elements 182 with different structures are introduced into the beam path of the projection unit 115. In an alternative, line structures may be used for both partial measurements. In this case, a correction factor by means of which the limited surface area of the luminous structure is taken into account is used in the colorimetric and photometric evaluation. Should for example a double crosshair or a ring be used, the optical magnification is optionally also ascertained by measurement and taken into account on an individual basis in the calculation. Examples of object structures to be projected are depicted in FIGS. 3 to 6.

For example, the light source 125 of the projection unit 115 is polychromatic, wherein a suitable mechanism that allows delimitation or adjustment of the spectral bandwidth may be present. For example, the light source 125 is realized as a single, polychromatic LED with appropriate spectral filtering or as a combination of a plurality of monochromatic beam sources. In an alternative, the projection unit may also be designed such that the latter itself generates a virtual object structure by way of a self-luminous element, for example a display.

The apparatus 100 moreover comprises the optical receiver unit 110, which is arranged on the opposite side vis-à-vis the projection unit 115. Should the test specimen 105 be measured in reflection, the projection unit 115 and receiver unit 110 are arrangeable on the same side. In the case of FIG. 1 illustrated here, the measurement is shown in transmission by way of example. However, the approach works equally for a measurement in reflection.

The receiver unit 110 in turn comprises an optical system described as optics device 135 and an image sensor which may be realized as a multispectral detector 140, i.e. a detector with a plurality of spectral channels. Other embodiments include monochromatic detectors with filter units or separate channels for spectrometric evaluations. Expressed differently, the spectral sensitivity of the image sensor is modifiable. Hence the image sensor is able to spectrally weight and/or filter incident light beams. For example, the spectral sensitivity of the sensor is adaptable to that of the human eye as a result. In an exemplary embodiment, such a detector 140 is realizable with the aid of a combination of at least one filter wheel with V(lambda) filters and with an additional ND filter. According to this exemplary embodiment, the optics device 135 is arranged upstream of the detector 140 and designed such that it generates a diffraction-limited image representation for its entire capturable viewing angle range (FOV). Furthermore, the optics device 135 comprises one or more interchangeable components, and so it is possible to adapt the FOV of the optics device 135 to different measurement specifications. In the case of a maximally set FOV, the design of the optical system for example corresponds to that of a conoscope, with the first optical element always being an adjustable optics aperture stop 144, as depicted in FIG. 1 or FIG. 2. The latter is preferably realized as a physical stop, but alternatively also as a virtual pupil.

In accordance with the exemplary embodiment depicted in FIGS. 1 and 2, both the projection unit 115 and the receiver unit 110 are furthermore secured to respective goniometers 146, 147, which can be pivoted or displaced laterally independently of one another, either once or repeatedly. For example, the axes about which the projection and receiver units are pivotable extend approximately parallel to the respective optical axes and/or intersect the respective entrance and exit pupils centrally. To realize a lateral offset, each goniometer 146, 147 may also be mechanically connected to a multi-axis linear stage. Pivoting and/or displacing the projection unit 115 is required for illuminating the test specimen 105 at different positions and/or at different object angles or for providing the object pattern at different positions or at different object angles. An application is displayed by way of example in FIG. 2 below.

Expressed differently and/or in summary, the apparatus 100 for measuring the imaging quality of optical systems or modules of NED systems is presented in this exemplary embodiment, wherein the apparatus 100 comprises the projection unit 115, a mounting unit 145, which is also referred to as mechanical receptacle for the optical system or module to be tested or for the test specimen 105 and which is translationally displaceable in three spatial directions, the optical receiver unit 110 and the computing unit 150. In this case, the apparatus 100 is able to simultaneously determine optical and also photometric or colorimetric measurement parameters of the optical system or module 105 to be tested, wherein the optical receiver unit 110 consists of an optical imaging system, which was described previously as optics device 135, and an optical detector 140 having a plurality of spectral channels 141. For example, the optical detector 140 is realizable by way of a combination of an image sensor 142 with at least one filter element 143, for example an upstream filter wheel with V(lambda) filters and an optional, further ND filter. According to this exemplary embodiment, the optical receiver unit 110 comprises an optical system 135 which is diffraction-limited for the entire, capturable field angle. The optical system, i.e. the optics device 135 of the receiver unit 110, moreover optionally comprises interchangeable components and at least one physically or virtually adjustable optics aperture stop 144, and so it is possible to delimit the diameter of the incident beams, for example in order to simulate the extent of the human iris. Furthermore, in terms of its design the optical system 135 may correspond to a conoscope.

According to this exemplary embodiment, the projection unit 115 is realized merely optionally as a focusable or non-focusable collimator with a monochromatically and/or polychromatically illuminated line element 182 (reticle) and also comprises a physical or virtual aperture stop, which was described previously as exit aperture 180. The aperture stop may optionally be adjustable in order to limit the diameter of the beams incident on the test specimen. Furthermore, the projection unit 115 may contain an adjustable field stop 181, which may also be realized physically or virtually. It serves to adapt the field angles of the emerging beams. Such an adaptation may be required for some test specimens in order to accurately adapt the input coupling angle into a waveguide to be tested. Furthermore, the line element 182 optionally contains different object structures (multi-feature reticle) or is designed such that an interchange mechanism can be used to sequentially introduce reticules with different object structures into the beam path of the projection unit 115. In this case, the object structures are for example realizable both as large-area elements and as sharp edges or lines, which are generated as virtual structures with the aid of a self-luminous element. Expressed differently, this means that the projection unit 115 comprises the at least one line element 182 with a plurality of different object structures or an interchange mechanism for sequentially introducing different line elements, for example reticules, with different object structures into a beam path of the light 120, in particular wherein the object structures represent large-area elements, sharp edges and/or lines, which for example are bent or straight. In this case, the object structures are generated or generable as virtual structures with the aid of a self-luminous element. In addition to that or in an alternative, the projection unit 115 comprises a physical or virtual projection aperture stop 180 and an optional, physical or virtual, projection field stop 181.

According to this exemplary embodiment, the projection unit 115 is designed to illuminate the test specimen 105 in reflection or transmission. To this end, the projection unit 115 is arranged on the first goniometer 146, for example, and the receiver unit 110 is arranged on the second goniometer. As a result, both units 110, 115 are pivotable in at least two directions about their respective single defined points of rotation. Accordingly, each goniometer 146, 147 is translationally movable in three spatial directions relative to the test specimen 105 to be tested. The goniometers are not mandatory for the functioning of the apparatus. In such a case, the receiver unit would be realized as conoscope, and the projection unit would have an adjustable aperture- and field stop, in order to adapt the diameter and the field angles of the light beams to the test specimen. Overall, the test specimen for example takes the form of a waveguide, a combination of waveguides or a module that consists of a combination of illumination unit and waveguide, wherein the module is capable of generating a self-luminous object structure that can be captured by the receiver unit 110 of the apparatus 100.

FIG. 2 shows a schematic illustration of an exemplary embodiment of an apparatus 100. The apparatus 100 depicted here is similar to the apparatus 100 described in FIG. 1. According to this exemplary embodiment, the apparatus 100 depicted here once again comprises the projection unit 115 in addition to the receiver unit 110, the computing unit 150 and the mounting unit 145 that holds the test specimen 105. The test specimen depicted here does not comprise an independent, active illumination- or projection element 155. According to this exemplary embodiment, the light 120 enters the test specimen 105 via the entrance point 165 and is reflected off the surfaces of the test specimen 105 until it reaches the exit point 170 and the light beams 130 are transmitted to the receiver unit 110. According to this exemplary embodiment, too, the projection unit 115 is realized as a focusable or non-focusable collimator, which in particular comprises at least one monochromatically and/or polychromatically illuminated or illuminable line element 182 (reticle). It is also conceivable that the (image) sensor 142 is focusable accordingly. A collimator is designed to generate light with an approximately parallel beam path from a divergent source. This collimation frequently serves to impart a specific direction on the light.

Expressed in other words, the imaging quality of the test specimen 105, for example of a single waveguide, is measured with the aid of the apparatus 100 in the case depicted in FIG. 1. In the process, the projection unit 115 is positioned in such a way that the object pattern is projected into the entrance pupil 165. The object pattern may also be projected into other regions of a waveguide of an NED module. Thus, in the case of a module for AR glasses, the projection unit 115 simulates a real object from the surroundings of a user. In this application, the exposure unit of the NED module likewise generates, merely on an optional basis, a self-luminous structured object pattern that in addition or as an alternative to the object pattern of the projection unit 115 is captured by the receiver unit 110. In this context, pivoting of the receiver unit 110 is for example required in order to record an image representation of the object pattern at different field angles. Expressed differently, an axis and an off-axis imaging quality is ascertained in this way. As a result of a lateral displacement of the receiver unit 110, the optical and the photometric or colorimetric parameters of the optical system to be measured or of the NED module are determined at different positions within an eye box.

The apparatus 100 moreover comprises the computing unit 150, with the aid of which both the projection unit 115 and the receiver unit 110 are controlled electronically. For example, the computing unit 150 is designed to control the projection unit 115 in order to introduce different object patterns into the beam path should a corresponding reticle interchange mechanism be used. In the process, large-area structures are used to determine colorimetric or photometric parameters, and structures with sharp lines or edges are used to determine optical imaging parameters.

The computing unit 150 processes images that are recorded by the sensor associated with the receiver unit 110 and, from the recorded images, calculates the desired optical and colorimetric or photometric imaging parameters of the test specimen 105 to be measured. For example, the computing unit 150 controls the image sensor in such a way that the latter sequentially records images of the object structure projected by the test specimen 105, for each available spectral channel. In this case, the exposure time of the sensor is also variable. In the case of an exemplary use of a filter wheel, the change of a spectral channel means a change in the filter position of said filter wheel. For each filter position, both one image and a plurality of images are recorded, for example, and transmitted to the computing unit 150.

In this case, the optical or colorimetric or photometric parameters are ascertained, for example for each individual one of the recorded images or else for any desired combination of individual images. For example, sequentially recorded images each with a different exposure time are thus combinable to form one or more high dynamic range (HDR) images. In an alternative, sequentially recorded images with in each case a different spectral weighting are combined to form one or more color images. When examining NED complete systems or modules, the computing unit 150 is also additionally or alternatively connected to the test specimen 105. In such a case, the projection unit 115 and/or the further projection unit (not depicted here) of the test specimen 105 are controlled such that these display a self-luminous object structure. An example of such a self-luminous object structure would be a crosshair pattern or a ring, which are depicted merely by way of example by an LCD or LED display. The computing unit 150 also purely optionally comprises calibration data for the measuring apparatus, which were read in advance of the measurement and with the aid of which aberrations, for example a degree of distortion, of optics units used in the projection unit 115 or receiver unit 110 can be removed by calculation from the subsequent measurement data.

FIG. 3 shows a schematic illustration of an exemplary embodiment of an object structure 300 for an apparatus, as described by way of example in at least one of FIGS. 1 and 2. For example, the object structure 300 is designed as a structure that is used to determine an imaging quality of a test specimen.

According to this exemplary embodiment, the object structure 300 has a dark region 305 and a light region 310, which are separated from one another by way of a sharply delimited edge. In this case, the object structure 300 takes the form of a cross. Furthermore, the object structure 300 according to this exemplary embodiment has a polygonal contour.

FIG. 4 shows a schematic illustration of an exemplary embodiment of an object structure 300 for an apparatus, as described by way of example in at least one of FIGS. 1 and 2. For example, the object structure 300 is designed as a structure that is used to determine an imaging quality of a test specimen.

According to this exemplary embodiment, the object structure 300 has a dark region 305 and a light region 310, which are separated from one another by way of a sharply delimited edge. In this case, the object structure 300 takes the shape of a circle, in particular a ring, and so the object structure 300 according to this exemplary embodiment has a further dark region 400. Furthermore, the object structure 300 according to this exemplary embodiment has a polygonal contour.

FIG. 5 shows a schematic illustration of an exemplary embodiment of an object structure 300 for an apparatus, as described by way of example in at least one of FIGS. 1 and 2. For example, the object structure 300 is designed as a structure that is used to determine an imaging quality of a test specimen.

According to this exemplary embodiment, the object structure 300 has a dark region 305 and a light region 310, which are separated from one another by way of a sharply delimited edge. In this case, the object structure 300 according to this exemplary embodiment takes the shape of a square. Furthermore, the object structure 300 according to this exemplary embodiment has a polygonal contour.

FIG. 6 shows a schematic illustration of an exemplary embodiment of an object structure 300 for an apparatus, as described by way of example in at least one of FIGS. 1 and 2. For example, the object structure 300 is designed as a structure that is used to determine an imaging quality of a test specimen.

According to this exemplary embodiment, the object structure 300 has a dark region 305 and a light region 310, which are separated from one another by way of a sharply delimited edge. Additionally, the object structure 300 according to this exemplary embodiment has the further dark region 400 and a further light region 600. According to this exemplary embodiment, the light regions 310, 600 and the dark regions 305, 400 are in each case arranged diagonally to one another such that all regions 305, 310, 400, 600 meet at a common center 605 of the object structure 300. Furthermore, the object structure 300 according to this exemplary embodiment has a round contour.

FIG. 7 shows a flowchart of an exemplary embodiment of a method 700 for determining an imaging quality of an image representation for a test specimen. For example, the method 700 is performable by a computing unit for an apparatus as described in either of FIGS. 1 and 2. For example, the computing unit takes the form of a controller.

Accordingly, the method 700 comprises a step 705 of emitting light using the projection unit, for example for an adjustable duration, in order to project at least one luminous and/or illuminated object structure onto the test specimen. Furthermore, the method 700 comprises a step 710 of receiving, using the receiver unit, light beams of light transmitted through or reflected off the test specimen, said light beams representing at least one image representation, and a step 715 of simultaneously evaluating a first light parameter and a second light parameter of light beams of light transmitted through or reflected off the test specimen. In this case, the first light parameter represents at least one optical light parameter, and the second light parameter represents at least one colorimetric or photometric light parameter, in order to determine the imaging quality of the at least one image representation simultaneously using the computing unit. Purely optionally, further light beams of light transmitted through or reflected off the test specimen are received in the reception step 710, said further light beams representing at least one further image representation. This means that, in this case, a further first light parameter, which represents at least one further optical light parameter, and a further second light parameter, which represents at least one further colorimetric light parameter, of the further light beams are evaluated simultaneously in the evaluation step 715 in order to determine a further imaging quality of the further image representation. In particular, the image representation and the further image representation were captured at respective different exposure times to this end.

Additionally, albeit optionally, the method 700 according to this exemplary embodiment comprises a step 720 of compensating for and hence correcting aberrations, for example a distortion, using specified calibration data before the evaluation step 715 and/or a step 725 of combining the image representation and the further image representation to form an overall image after the evaluation step 715. For example, this is implemented to form an overall HDR image in the case of different exposure times or to form an overall color image in the case of different spectral settings. In this case, parameters for individual images or for overall images, for example, are determined.

Expressed in other words, the method 700 for measuring the imaging quality of optical systems or modules in NED systems is described, wherein a luminous and/or illuminated object structure is projected in the emission step 705, said object structure being transmitted by the optical system or module to be tested or being reflected off the latter. In the reception step 710, one or more image representations of the transmitted or reflected object structure are received by the receiver unit for different spectral settings of the detector. Accordingly, one or more optical and colorimetric or photometric parameters of the optical system or module to be tested are determined simultaneously with the aid of the computing unit from the one or more image representations in the evaluation step 715. An adjustable exposure time of the detector is purely optional, wherein a plurality of images that are each captured during a different exposure time are combinable with the aid of the computing unit to form an overall HDR image. Further, images captured for different spectral settings are combined with the aid of the computing unit to form an overall image in the combination step 725, wherein the optical and colorimetric or photometric parameters are purely optionally determinable for each individual image and/or for combined overall images.

FIG. 8 shows a block diagram of a computing unit 150 according to an exemplary embodiment for an apparatus as described for example in at least one of FIGS. 1 and 2. Accordingly, the computing unit 150 is for example designed to control and/or perform a method for determining an imaging quality of at least one image representation for a test specimen, for example as described in FIG. 7. Accordingly, the computing unit 150 comprises an emission unit 800, a reading unit 805 and an evaluation unit 810. Purely optionally, the computing unit 150 additionally comprises a compensation unit 815 and/or a combination unit 820.

In this case, the emission unit 800 is designed to bring about an emission of light using the projection unit, in order to project at least one luminous and/or illuminated object structure onto the test specimen. For example, the reading unit 805 is designed to read light beams of light transmitted through or reflected off the test specimen and received by the receiver unit of the apparatus, meaning for example a first light parameter 825 and a second light parameter 830 of the light beams. The evaluation unit 810 is designed to simultaneously evaluate the first light parameter 825, which represents at least one optical light parameter, and the second light parameter 830, which represents at least one colorimetric or photometric light parameter, of light beams of light transmitted through or reflected off the test specimen, in order to determine the imaging quality of the at least one image representation simultaneously. Purely optionally, the reading unit 805 is further designed to read further light beams of further light transmitted through or reflected off the test specimen and received by the receiver unit of the apparatus, meaning for example a further first light parameter 831, which represents at least one further optical light parameter, and a further second light parameter 832, which represents at least one further colorimetric or photometric light parameter, of the further light beams. Consequently, the evaluation unit 810 is designed to simultaneously evaluate the further first light parameter 831 and the further second light parameter 832 of the further light beams in order to determine a further imaging quality of the further image representation, in particular wherein the image representation and the further image representation were each captured at different respective single exposure times.

The compensation unit 815 is further optionally embodied to bring about a compensation for or correction of aberrations using specified calibration data 835. For example, the combination unit 820 is designed to combine the image representation and a purely optional further image representation in order to obtain an overall image.

In summary, as regards the type of optical systems to be tested, it should be noted that the envisaged application of the apparatus for which patent protection is sought lies in modules for AR/VR systems. Specifically, this may relate to individual waveguides or else waveguides with a dedicated projector (e.g. for AR glasses). The measuring system in turn for example only comprises a projection apparatus and a receiver apparatus. For example, both can be pivotable or displaceable. Specifically, the second projection unit is not a general constituent part of the measuring system. It is only present if an NED module is measured, for example as described in FIG. 1. In the case of the system constructed according to FIG. 1, this would be an application example which considers how well the waveguide transmits the images generated by the NED projector (e.g. on AR glasses), in comparison with the representation of the real surroundings, from a metrological point of view.

As regards the comparison of a spectral filter with an ND filter, it should be noted that a distinction between for example two types of filters should be made in the receiver unit. Spectral filters ensure that a desired wavelength range may be set, in particular for the colorimetric measurements. Examples include V(lambda) filters for adaptation to the spectral sensitivity of the human eye or Beyer patterns (weighted distribution of RGB filters) in CCD cameras. ND filters reduce the luminous intensity, independently of the spectrum. Both types of filters may be used in practice.

As regards the adaptation of field angles and beam cross-sections, it should be noted that on the receiver side for example there is no need for adaptation of the field angle of the light beams. Here, an optics unit with a suitable FOV is selected, e.g. a conoscope for large field angles. However, adapting the beam cross section is helpful, e.g. should the iris of the human eye be simulated, hence the adjustable aperture stop 144. Adaptation of both the beam cross section and its field angle may be required on the projection side. Hence, the field stop 181 is also proposed in FIG. 1. (The image representation of the field stop is a hatch.) Adaptation of the beam cross section is helpful to prevent overexposure of the test specimen, as this may lead to bothersome effects, e.g. stray light. The field angle should be adaptable in order to obtain a desired input coupling angle into the waveguide since not necessarily every possible total-internal reflection is wanted in this case.

1. An apparatus for determining an imaging quality of at least one image representation for a test specimen, the apparatus comprising the following features:
at least one projection unit for emitting light in the direction of the test specimen in order to project at least one luminous and/or illuminated object structure onto the test specimen;
an optical receiver unit for receiving light beams of light trans-mitted through or reflected off the test specimen, said light beams representing at least one image representation of the projected object structure, wherein the receiver unit comprises an optics device and an optical detector;
a mounting unit for holding the test specimen to be tested, wherein the mounting unit is arranged between the projection unit and the optical receiver unit; and
a computing unit for simultaneously evaluating a first light parameter, which represents at least one optical light parameter, and a second light parameter, which represents at least one colorimetric and/or photometric light parameter, of light beams of light transmitted through or reflected off the test specimen and received using the receiver unit, in order to deter-mine the imaging quality of the at least one image representation for the test specimen, wherein the computing unit is connected to the projection unit, to the receiver unit and/or to the mounting unit.

2. The apparatus as claimed in claim 1, wherein the detector associated with the receiver unit comprises a plurality of spectral channels and at least one image sensor, in particular wherein the detector associated with the receiver unit is realized as a focusable camera.

3. The apparatus as claimed in claim 1, wherein the receiver unit comprises the optics device, which is diffraction-limited for an entire capturable field angle.

4. The apparatus as claimed in claim 3, wherein the optics device comprises interchangeable components and at least one adjustable optics aperture stop, which is designed to adapt geometric properties of the beams incident into the optics device.

5. The apparatus as claimed in claim 1, wherein the projection unit takes the form of a focusable or non-focusable collimator, which in particular comprises at least one monochromatically and/or polychromatically illuminated or illuminable line element.

6. The apparatus as claimed in claim 5, wherein the projection unit comprises the at least one line element with a plurality of different object structures, or wherein the projection unit comprises an interchange mechanism for sequentially introducing different line elements with different object structures into a beam path of the light, in particular wherein the object structures represent large-area elements, sharp edges and/or lines.

7. The apparatus as claimed in claim 1, wherein the object structures are generated or generable with the aid of a self-luminous element, and/or wherein the projection unit comprises a projection aperture stop and/or a projection field stop.

8. The apparatus as claimed in claim 1, having a movable first goniometer, which is connected to the projection unit, and having a movable second goniometer, which is connected to the receiver unit, wherein the first and second goniometers are designed to move the projection unit and the receiver unit independently of one another in at least two different directions about their respective single defined points of rotation, in particular wherein the first goniometer and/or the second goniometer is or are translationally movable in at least three spatial directions relative to the test specimen.

9. A method for determining an imaging quality of at least one image representation for a test specimen using an apparatus as claimed in claim 1, wherein the method comprises the following steps:
emitting light using the projection unit in order to project at least one luminous and/or illuminated object structure in the direction of the test specimen;
receiving light beams of light transmitted through or reflected off the test specimen and representing at least one image representation, using the receiver unit; and
simultaneously evaluating a first light parameter, which represents at least one optical light parameter, and a second light parameter, which represents at least one colorimetric or photometric light parameter, of light beams of light transmitted through or reflected off the test specimen, in order to determine the imaging quality of the at least one image representation simultaneously using the computing unit.

10. The method as claimed in claim 9, wherein further light beams of further light transmitted through or reflected off the test specimen are received in the reception step, said further light beams representing at least one further image representation, wherein a further first light parameter, which represents at least one further optical light parameter, and a further second light parameter, which represents at least one further colorimetric or photometric light parameter, of the further light beams are simultaneously evaluated in the evaluation step in order to determine a further imaging quality of the further image representation, in particular wherein the image representation and the further image representation were captured at different respective single exposure times.

11. The method as claimed in claim 10, having a step of combining the image representation and the further image representation to form an overall image after the evaluation step.

12. The method as claimed in claim 9, having a step of compensating for aberrations using predetermined calibration data before the evaluation step.

13. A computing unit for an apparatus, wherein the computing unit is designed to control and/or perform the method as claimed in claim 9 in corresponding units.

14. A computer program configured to execute and/or control the steps of the method as claimed in claim 9.

15. A machine-readable storage medium, on which the computer program as claimed in claim 14 is stored.
